(19) United States
(12) Patent Application Publication
(10) Pub. No.: US 2012/0230430 A1
(43) Pub. Date: Sep. 13, 2012

(54) Parameter Set Maintenance in Video Coding

(76) Inventor: Stephan Wenger, Hillsborough, CA (US)

(21) Appl. No.: 13/407,000

(22) Filed: Feb. 28, 2012

Related U.S. Application Data
(60) Provisional application No. 61/451,286, filed on Mar. 10, 2011.

(51) Int. Cl. H04N 7/12

(52) U.S. Cl. 375/240.25; 375/E07.026

(57) ABSTRACT

Systems and methods for decoding include receiving a parameter set NAL unit including a reference ID and at least one flag f(n); for all n, if the at least one flag f(n) is not set, maintaining the values v(n) of a parameter set having the same reference ID, and if the at least one flag f(n) is set, replacing the values v(n) of the parameter set having the same reference ID with the values v(n) of the received parameter set NAL unit.

### PRIORITY CLAIM

This application claims priority to U.S. Provisional Application Ser. No. 61/451,286, filed Mar. 10, 2011, titled “Parameter Set Maintenance in Video Coding,” the disclosure of which is hereby incorporated by reference in its entirety.

### FIELD

The present application relates to video coding, and more specifically, to the representation of information related to updates of parameter sets in video coding standards such as ITU-T Rec. H.264 “Advanced video coding for generic audiovisual services”, 03/2010, available from the International Telecommunication Union (“ITU”), Place de Nations, CH-1211 Geneva 20, Switzerland or http://www.itu.int/rec/T-REC-H.264, and incorporated herein by reference in its entirety.

### BACKGROUND

Referring to FIG. 1, ITU-T Rec. H.264 requires those parameters needed for the decoding process and that pertain to more than one slice to be available at the decoder (conveyed in the bitstream or out of band) in data structures known as parameter sets. Rec. H.264 includes two parameter set types: Picture Parameter Sets (112) (which pertain to a given picture); and Sequence Parameter Sets (111) (which pertain to a given sequence (also known as Group Of Pictures, or GOP)). A sequence and picture parameter set is “activated” when referenced by a field (105) in the slice header of a slice (106). The slice header contains a reference (107) to the to-be-activated picture parameter set (108) identified by its reference value. For example, for picture parameter set (101), its reference value (103) is 0. The picture parameter set contains a reference value (114) that creates a reference (109) to the to be activated sequence parameter set (110). A parameter set is referenced when its own reference value (such as: value (103) for picture parameter set (101), or value (113) for sequence parameter set (102)) is the same as the reference value in the slice header (105) (for the picture parameter set) or the referring picture parameter set (114) (for the sequence parameter set), respectively.

The decoder can provision for more than one parameter set location for each parameter set type (111) (112). For all slices of a picture, the slice headers refer to the same picture parameter set, and for all pictures of a sequence, the picture parameter set(s) used refer to the same sequence parameter set.

One common implementation strategy in a decoder is to maintain fixed length tables for each parameter set types. H.264 specifies the maximum size of such tables. Upon arrival of a parameter set NAL unit, the parameter set reference value (103) or (113) determine the storage location in the table. The differentiation between sequence and picture parameter set occurs through the NAL unit type (not depicted).

Other parameter set types, such as slice parameter sets, have been proposed, for example in JVT contribution NT-0078 “Coding of Parameter Sets” by M. Hannuksela and Y. K. Wang, May 2002, available from wftp3.itu.int/av-arch/jvt-site/2002_{—}05_Fairfax/JVT-C078.doc, which is incorporated herein in its entirety.

Referring to FIG. 4a shown is a parameter set (401) that could be a picture or a sequence parameter set. It should be emphasized that parameter set (401) contains only a single storage location reference (403). When received by a decoder, the storage location reference (403) can be used to identify the storage location of the parameter set in the parameter set table that can be maintained by the decoder, as already described.

Referring to FIG. 2, for example in a decoder compliant with ITU-T Rec. H.264, parameter sets need to be conveyed in their entirety. A newly generated and transmitted (to a decoder) parameter set (201) contains as one of its parameters its reference identification (ID) (202), which can be used to refer to a storage location (203) in a parameter set table (204). Upon decoding, a received parameter set is stored (205) by the decoder in the location (203) indicated by the ID (202). Parameter sets can contain optional part(s) (206), indicated here by grayshade. Those optional parts, when not conveyed, are undefined once the parameter set is stored in the location (203), even if they were defined before by the transmission of a parameter set to the same location (203) with the optional data. In other words, the transmission of a parameter set with undefined data portions invalidates even those portions in the entry in the parameter set table that were previously defined. While H.264 does not use such a mechanism, an undefined portion of a parameter set can conceivably carry a semantic. For example, if a given portion of a parameter set is undefined, a decoder can infer the use of default values that can, for example, be defined in a standard.

It can be advantageous from a coding efficiency viewpoint to update only parts of a parameter set, rather than sending the whole updated parameter set. It can also be advantageous to (selectively) “undefine” parts of a parameter set so to force a decoder to fallback to default values, without retransmitting the other parts of the parameter set. It can further be advantageous to allow for a copy of parameter set content in the decoder from one given location to another, for example to update the copied version of the parameter set to implement small changes to a largely unchanged parameter set.

Therefore, it can be desirable that in a video bitstream or out of band, a mechanism allows to update, undefine, and/or to copy one or more parameter sets or parts thereof.

### SUMMARY

The disclosed subject matter provides for techniques for parameter set maintenance. Disclosed are a parameter set update mechanism by conditional replacement that can affect one or more parameter sets, a parameter set maintenance message for un-defining a parameter set or parts thereof, and a parameter set maintenance message that allows to copy the content of an indicated parameter set to an indicated location of a different parameter set.

In one embodiment, upon reception of a parameter set NAL unit of the same type and with the same ID as a parameter set previously received and decoded, those values in the previously received and decoded parameter set that are not present in the newly received parameter set NAL unit are kept. In the same or another embodiment, a syntax element is used to indicate which of one or more values of a parameter set are present in the parameter set NAL unit. Also disclosed are techniques to copy and/or invalidate whole parameter sets are parts thereof.

In the same or another embodiment, a flag can indicate the presence of a value of a parameter set NAL unit. Upon reception of the parameter set NAL unit, the decoder overwrites those parts of the parameter set in its state for which the flag is set, and leaves intact those parts of the parameter set for which the flag is cleared.

In the same or another embodiment, a parameter set NAL unit can include more than one storage location.

In the same or another embodiment, a parameter set maintenance data structure is present in the bitstream.

In the same or another embodiment, the parameter set maintenance data structure is in the form of a NAL unit.

In the same or another embodiment, the parameter set maintenance data structure can contain at least one of a copy command and an invalidation command.

In the same or another embodiment, the copy command can include a source parameter set ID and a destination parameter set ID.

In the same or another embodiment, the invalidation command can include a parameter set ID to be invalidated.

### BRIEF DESCRIPTION OF THE DRAWINGS

Further features, the nature, and various advantages of the disclosed subject matter will be more apparent from the following detailed description and the accompanying drawings in which:

FIG. 1 is a schematic illustration of parameter sets in accordance with Prior Art (ITU-T Rec. H.264);

FIG. 2 is a schematic illustration of parameter set transmission in accordance with Prior Art;

FIG. 3 is a schematic illustration of a parameter set update in accordance with an embodiment of the present invention;

FIG. 4a is a schematic illustration of a parameter set in accordance with Prior Art.

FIG. 4b is a schematic illustration of a parameter set that can be stored in multiple locations in accordance with an embodiment of the present invention;

FIG. 5 is a schematic illustration of a parameter set maintenance message in accordance with an embodiment of the present invention; and

FIG. 6. shows a computer system suitable for implementing an embodiment of the present invention.

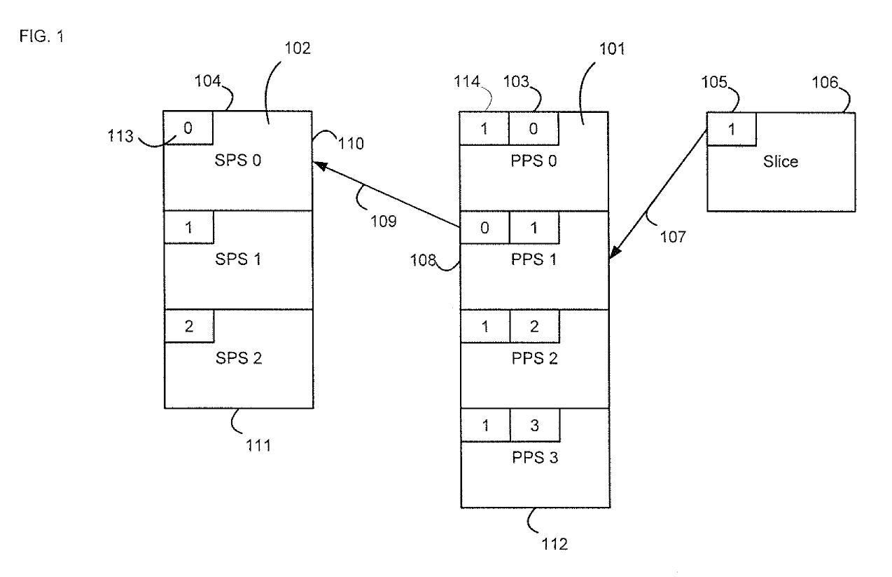

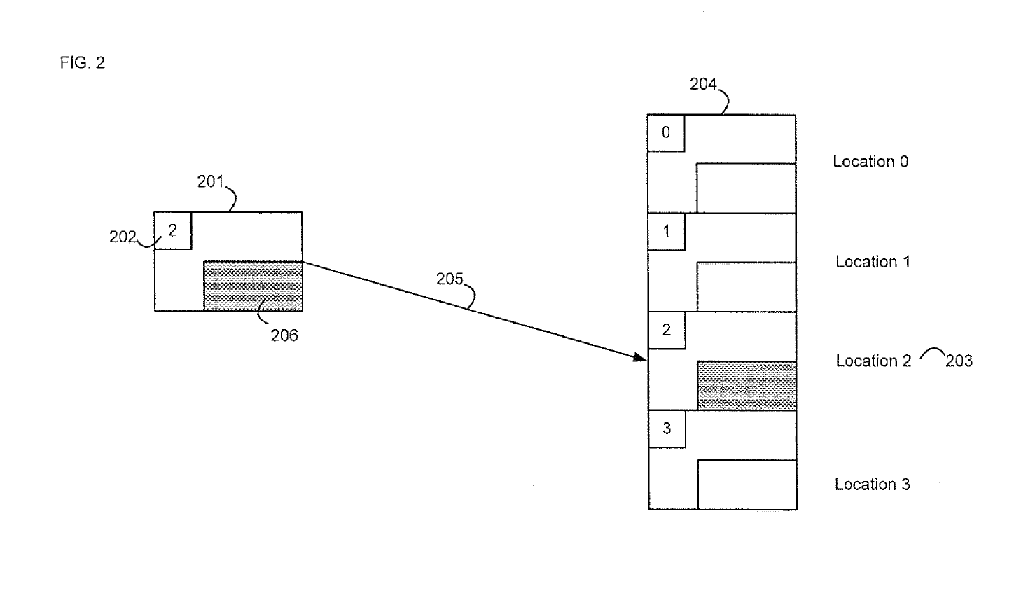

The Figures are incorporated and constitute part of this disclosure. Throughout the Figures the same reference numerals and characters, unless otherwise stated, are used to denote like features, elements, components or portions of the illustrated embodiments. Moreover, while the disclosed subject matter will now be described in detail with reference to the Figures, it is done so in connection with the illustrative embodiments.

### DETAILED DESCRIPTION

Described herein are: techniques for parameter set maintenance, namely 1) parameter set updates through conditional replacement of parts of a parameter set, 2) the use of multiple parameter set ID values to force a decoder to store and/or conditionally replace the content of a received parameter set NAL unit in more than one storage location; messages allowing to copy or invalidate whole parameter sets; and a technique that allows for invalidation of only a part of a parameter set.

For convenience, the present disclosure describes the disclosed subject matter assuming an implementation strategy that involves storing parameter sets at identified locations in a parameter set table and, therefore, refers to storage locations, parameter set tables and table entries, and similar terminology. Other implementation strategies may also be possible and the disclosed subject matter can be used in those implementations as well.

Parameter Set Update

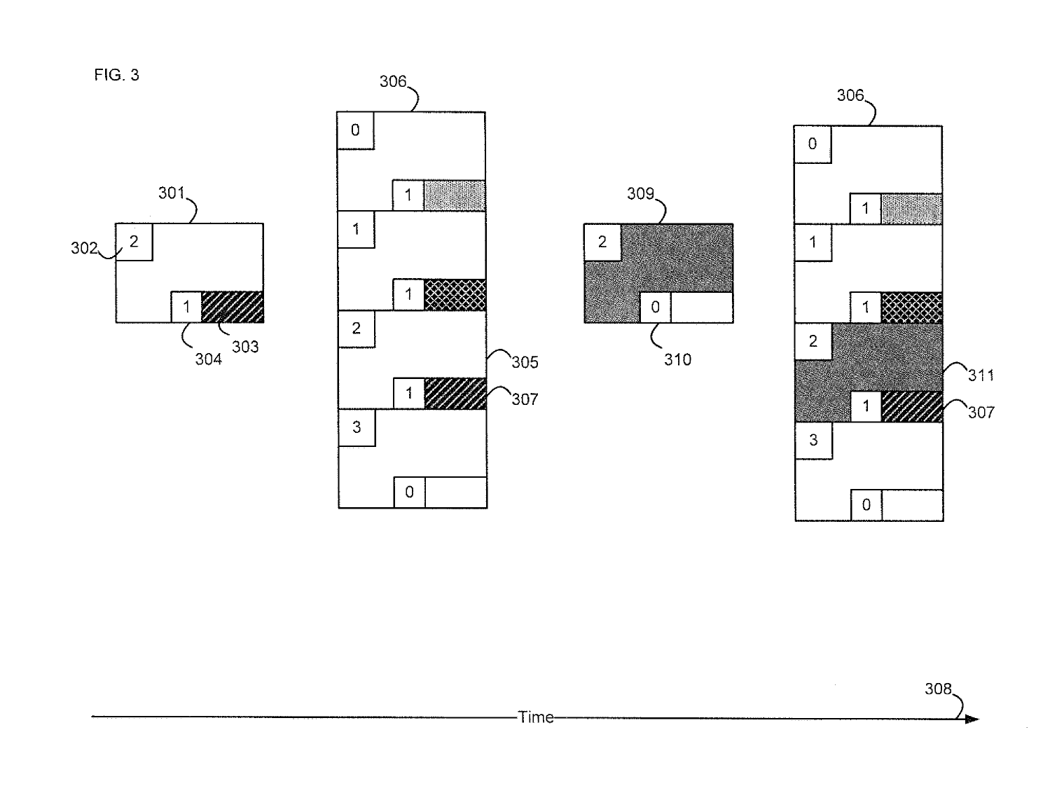

FIG. 3 shows a parameter set (301) (that could be a picture parameter set, sequence parameter set, or any other form of parameter set), to be stored at location “2” as indicated by the value “2” in the parameter set ID (302), that contains an optional part (303), whose presence is signaled by a flag (304). The optional part (303) has certain content, identified here through diagonal shading, and the flag (304) is set, identified here through the digit “1”.

After reception and processing by a decoder, the parameter set is stored in location “2” (305) in a parameter set table (306). The optional part, as it was present, has also been stored, as indicated by diagonal shading (307). The term “stored” for example, can mean that the parameter set can be retrieved by referencing its parameter set ID (value “2”). Storing it in a table at location 2 is but one convenient form of organizing parameter sets.

Further down the timeline (308), another parameter set (309) is received, also to be stored at location “2”, but with the optional part not coded (as indicated by flag (310) set to “0”.

After reception and processing by a decoder, according to an embodiment, the received parameter set is stored at the location indicated in the parameter set; here: location “2” (311). The content of a part of the parameter set can have changed since the last transmission, indicated by grayshade (307).

According to an embodiment, after reception, the optional part is not undefined (as it would be according to Prior Art), but retains the values it had before, indicated here through grayshade (307).

The aforementioned mechanism allows for updates of parameter sets. Since a parameter set can contain many optional parts, each of which having a flag (or other information) indicating its presence or absence in the received parameter set, individual parts of the parameter set can be included or omitted from the sent parameter set, and omitted parts can be re-using the values that were previously transmitted.

Expressed more formally, assume a parameter set may include n values v(n). A value v(n) can be a single syntax element, or a group of syntax elements, that advantageously have some semantic relationship. For example, a group of syntax elements could be formed that relate to all information pertaining to loop filter control, flexible macroblock ordering, or similar tools.

A set of flags f(n) can be inserted for the n values, where f(n) indicates the presence or absence of the v(n) in the parameter set NAL unit. For example, if f(n) is 0, then the parameter value v(n) may not be not present in the parameter set NAL unit, and if f(n) is 1, then parameter v(n) may be present in the parameter set NAL unit. The flags f(n) can be Boolean flags, or other representations can be chosen. For example, instead of having individual flags for each value v(n), one or more frequent combination of settings for flags f(n) could be grouped, and those groups can be signaled through an integer, expressed in, for example, a variable length code. Regardless of the actual representation of f(n), as a result, values v(n) in the parameter set NAL unit are now optional and their presence is indicated by f(n), in whatever representation f(n) is coded.

Using the mechanism already described, each of these optional values can be included or omitted in a parameter set update, thereby allowing for conditional replacement of one or more v(n) without the overhead of transmitting all v(n). For example, assume there are three values v(n)—that is, n is in the rage 0 through 2. A parameter set NAL unit can include f(0)=0, f(1)=1, and f(2)=0, with v(1) equaling the new settings for the value. Upon decoding of the parameter set NAL unit in the decoder, v(1) replaces the previously known v(1) in the decoder, but v(0) and v(2) remain as they were before decoding of the NAL unit.

The described update mechanism can work particularly well if there are many parameter sets that retain a large percentage of their values, but require a few changes. This use can be addressed by introducing the option of using more than one storage location in a parameter set transmission.

Multiple Parameter Set Reference Values

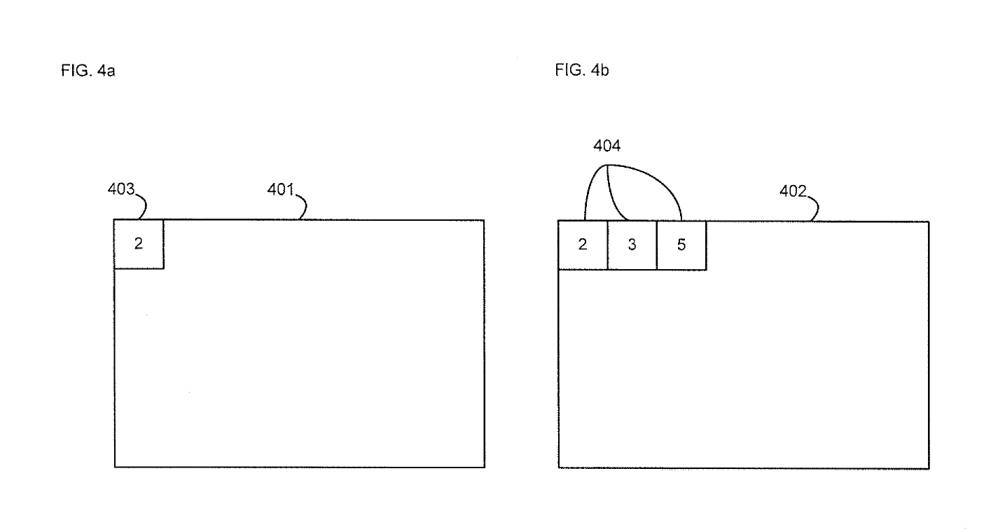

Referring to FIG. 4b, a parameter set received by a decoder (402) can include more than one parameter set reference value that can be used to indicate more than one storage location. Shown is a fixed number of three such locations (404). If any of these numbers were different from a pre-defined value indicating “do not store”, a decoder can store a copy of parameter set at the location provided. For example, assuming that the location references were coded in a binary integer format, the highest number can indicate a “do not store”. However, a variable number of such locations can be utilized. For example, an integer value can indicate the number of storage locations to follow, or a bit, associated with each storage location, can indicate whether another storage location follows.

Allowing multiple parameter reference values in a parameter set transmission allows for populating a parameter set table with a potentially large number of identical parameter sets with minimal overhead. These parameter sets can be modified using the parameter set update mechanism already described.

Parameter Set Copy Message

Another option to address the issue efficient transmission of multiple parameter sets with many identical values is the use of a copy command that can be encoded in a parameter set maintenance message.

In the syntax structure of ITU Rec. H.264, one appropriate place for parameter set maintenance messages can be a NAL unit type set aside for this purpose, by reserving a NAL unit type. However, other places in the bitstream may equally be appropriate.

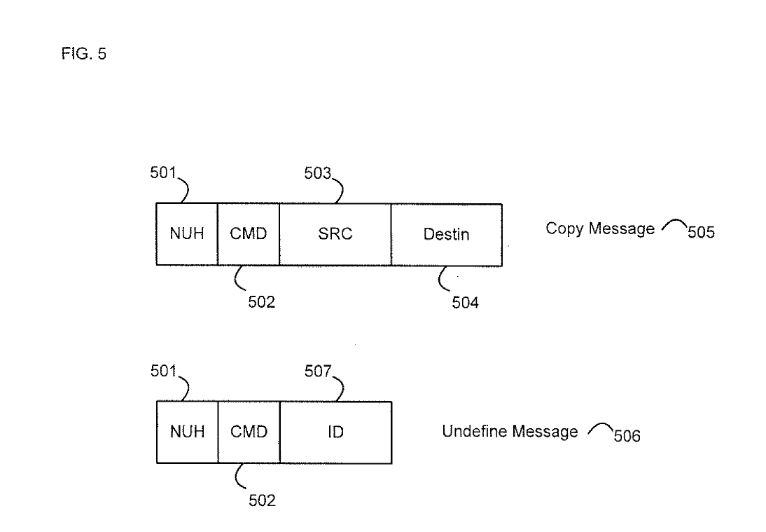

FIG. 5 shows an exemplary syntax for a parameter set maintenance NAL units. Specifically, shown are a copy message NAL unit (505) and a Undefine message NAL unit (506). Following the NAL unit header (NUH) (501) indicating, among other things, the NAL unit type (which can be coded according to prior art, such as ITU Rec. H.264, or other appropriate coding schemes), a bitfield CMD (502) can indicate the type of the maintenance command. Disclosed herein are two such commands, namely “copy” and “undefined”, but it can be advantageous to include an extension mechanism provisioning for future additional commands, which in this case can be implemented by making the CMD bitfield (502) larger than 1 bit (which would be the minimum to differentiate between the two messages “copy” and “undefined”).

Following the maintenance command type bitfield, other bits follow that can be specific to the maintenance command issued. For the copy command, one design choice is a bitfield for a source parameter set location (503), followed by another bitfield for a destination parameter set location (504). Other examples may allow the signaling of more than one destination, using mechanisms such as the ones already described above.

Parameter Set Invalidation Message

Still referring to FIG. 5, shown is also the syntax of an exemplary Undefine message (506). The Undefine message starts with a NAL unit header (501) and a CMD bitfield indicating the type of parameter set maintenance command, namely “undefine”. This can be followed by one or more identifications of parameter sets (507) that need to be set to an undefined state in their entireties.

Partial Parameter Set Invalidation

In some scenarios, it can be advantageous to set as “undefined” only parts of a parameter set (in contrast to the whole parameter set, as described above). As those parts of the parameter set need to be identified, the message can advantageously be not generic (such as the copy and undefine messages above), but rather specific, like the parameter set update message. One design choice is to include, at the beginning of each value field v(n), a flag u(n) indicating “undefined”. If a parameter set update message is sent, the flag f(n) is set, and the flag u(n) is also set, then the remainder of v(n) (if any) is ignored by the decoder, and v(n) is set as undefined.

It will be understood that in accordance with the disclosed subject matter, the parameter set maintenance techniques described herein can be implemented using any suitable combination of hardware and software. For example, an encoder can contain a parameter set coding module, that can use delta coding when appropriate (which saves bits on the wire). A decoder can include parameter set decoding module to take delta coded parameter sets from wire, and apply by not patching uncoded optional parts. The software (i.e., instructions) for implementing and operating the aforementioned rate estimation and control techniques can be provided on computer-readable media, which can include, without limitation, firmware, memory, storage devices, microcontrollers, microprocessors, integrated circuits, ASICs, on-line downloadable media, and other available media.

### Computer System

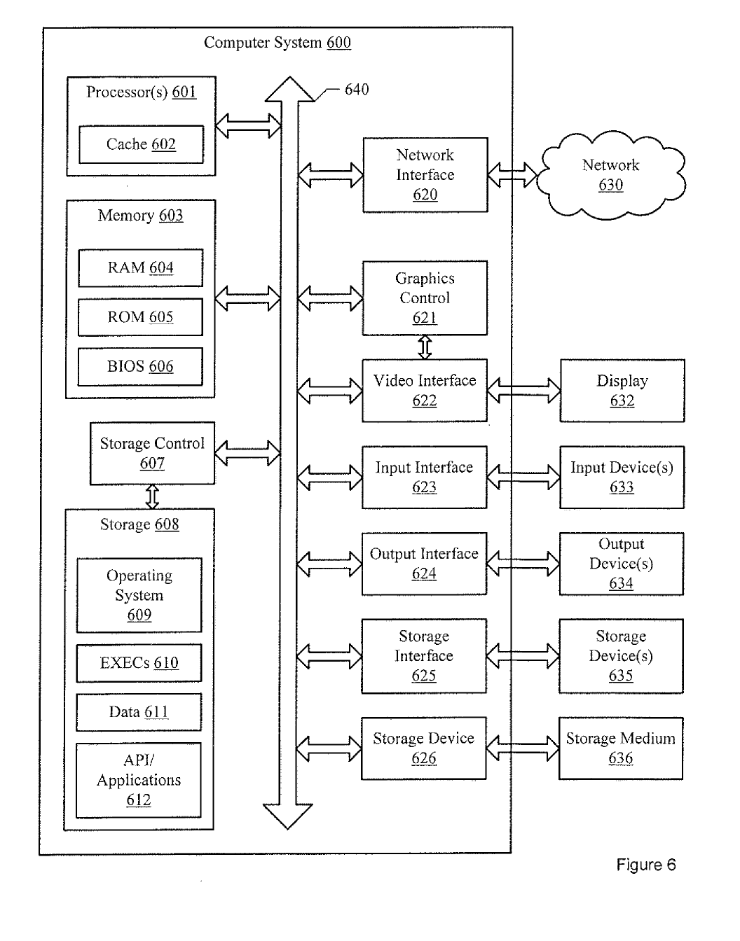

The methods described above can be implemented as computer software using computer-readable instructions and physically stored in computer-readable medium. The computer software can be encoded using any suitable computer languages. The software instructions can be executed on various types of computers. For example, FIG. 6 illustrates a computer system 600 suitable for implementing embodiments of the present disclosure.

The components shown in FIG. 6 for computer system 600 are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system. Computer system 600 can have many physical forms including an integrated circuit, a printed circuit board, a small handheld device (such as a mobile telephone or PDA), a personal computer or a super computer.

Computer system 600 includes a display 632, one or more input devices 633 (e.g., keypad, keyboard, mouse, stylus, etc.), one or more output devices 634 (e.g., speaker), one or more storage devices 635, various types of storage medium 636.

The system bus 640 link a wide variety of subsystems. As understood by those skilled in the art, a “bus” refers to a plurality of digital signal lines serving a common function. The system bus 640 can be any of several types of bus structures including a memory bus, a peripheral bus, and a local bus using any of a variety of bus architectures. By way of example and not limitation, such architectures include the Industry Standard Architecture (ISA) bus, Enhanced ISA (EISA) bus, the Micro Channel Architecture (MCA) bus, the Video Electronics Standards Association local (VLB) bus, the Peripheral Component Interconnect (PCI) bus, the PCI-Express bus (PCI-X), and the Accelerated Graphics Port (AGP) bus.

Processor(s) 601 (also referred to as central processing units, or CPUs) optionally contain a cache memory unit 602 for temporary local storage of instructions, data, or computer addresses. Processor(s) 601 are coupled to storage devices including memory 603. Memory 603 includes random access memory (RAM) 604 and read-only memory (ROM) 605. As is well known in the art, ROM 605 acts to transfer data and instructions uni-directionally to the processor(s) 601, and RAM 604 is used typically to transfer data and instructions in a bi-directional manner. Both of these types of memories can include any suitable of the computer-readable media described below.

A fixed storage 608 is also coupled bi-directionally to the processor(s) 601, optionally via a storage control unit 607. It provides additional data storage capacity and can also include any of the computer-readable media described below. Storage 608 can be used to store operating system 609, EXECs 610, application programs 612, data 611 and the like and is typically a secondary storage medium (such as a hard disk) that is slower than primary storage. It should be appreciated that the information retained within storage 608, can, in appropriate cases, be incorporated in standard fashion as virtual memory in memory 603.

Processor(s) 601 is also coupled to a variety of interfaces such as graphics control 621, video interface 622, input interface 623, output interface, storage interface, and these interfaces in turn are coupled to the appropriate devices. In general, an input/output device can be any of: video displays, track balls, mice, keyboards, microphones, touch-sensitive displays, transducer card readers, magnetic or paper tape readers, tablets, styluses, voice or handwriting recognizers, biometrics readers, or other computers. Processor(s) 601 can be coupled to another computer or telecommunications network 630 using network interface 620. With such a network interface 620, it is contemplated that the CPU 601 might receive information from the network 630, or might output information to the network in the course of performing the above-described method. Furthermore, method embodiments of the present disclosure can execute solely upon CPU 601 or can execute over a network 630 such as the Internet in conjunction with a remote CPU 601 that shares a portion of the processing.

According to various embodiments, when in a network environment, i.e., when computer system 600 is connected to network 630, computer system 600 can communicate with other devices that are also connected to network 630. Communications can be sent to and from computer system 600 via network interface 620. For example, incoming communications, such as a request or a response from another device, in the form of one or more packets, can be received from network 630 at network interface 620 and stored in selected sections in memory 603 for processing. Outgoing communications, such as a request or a response to another device, again in the form of one or more packets, can also be stored in selected sections in memory 603 and sent out to network 630 at network interface 620. Processor(s) 601 can access these communication packets stored in memory 603 for processing.

In addition, embodiments of the present disclosure further relate to computer storage products with a computer-readable medium that have computer code thereon for performing various computer-implemented operations. The media and computer code can be those specially designed and constructed for the purposes of the present disclosure, or they can be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher-level code that are executed by a computer using an interpreter. Those skilled in the art should also understand that term “computer readable media” as used in connection with the presently disclosed subject matter does not encompass transmission media, carrier waves, or other transitory signals.

As an example and not by way of limitation, the computer system having architecture 600 can provide functionality as a result of processor(s) 601 executing software embodied in one or more tangible, computer-readable media, such as memory 603. The software implementing various embodiments of the present disclosure can be stored in memory 603 and executed by processor(s) 601. A computer-readable medium can include one or more memory devices, according to particular needs. Memory 603 can read the software from one or more other computer-readable media, such as mass storage device(s) 635 or from one or more other sources via communication interface. The software can cause processor(s) 601 to execute particular processes or particular parts of particular processes described herein, including defining data structures stored in memory 603 and modifying such data structures according to the processes defined by the software. In addition or as an alternative, the computer system can provide functionality as a result of logic hardwired or otherwise embodied in a circuit, which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

While this disclosure has described several exemplary embodiments, there are alterations, permutations, and various substitute equivalents, which fall within the scope of the disclosed subject matter. It should also be noted that there are many alternative ways of implementing the methods and apparatuses of the disclosed subject matter.

I claim:

1. A method of decoding, comprising:
receiving a parameter set NAL unit including a reference ID and at least one flag f(n),
for all n, where n is the number of values in a parameter set:
if the at least one flag f(n) is not set, maintaining the values v(n) of a parameter set having the same reference ID, and
if the at least one flag f(n) is set, replacing the values v(n) of the parameter set having the same reference ID with the values v(n) of the received parameter set NAL unit.

2. The method of claim 1, wherein the at least one flag f(n) is represented as a Boolean value.

3. The method of claim 1, wherein the received parameter set NAL unit includes at least two flags f(n), the flags being grouped, and the values for f(n) within the group are represented by an integer.

4. The method of claim 2, wherein the received parameter set NAL unit includes at least two flags f(n), the flags being grouped, and the values for f(n) within the group are represented by an integer.

5. The method of claim 1, wherein the parameter set NAL unit contains a plurality of parameter set IDs.

6. The method of claim 2, wherein the parameter set NAL unit contains a plurality of parameter set IDs.

7. The method of claim 3, wherein the parameter set NAL unit contains a plurality of parameter set IDs.

8. A system for decoding, comprising:
a decoder configured to:
receive a parameter set NAL unit including a reference ID and at least one flag f(n), and decode the received parameter set NAL unit;
for all n, where n is the number of values in a parameter set:
if the at least one flag f(n) is not set, maintain the values v(n) of a parameter set having the same reference ID, and
if the at least one flag f(n) is set, replace the values v(n) of the parameter set having the same reference ID with the values v(n) of the received parameter set NAL unit.

9. The system of claim 8, wherein the at least one flag f(n) is represented as a Boolean value.

10. The system of claim 8, wherein the received parameter set NAL unit includes at least two flags f(n), the flags being grouped, and the values for f(n) within the group are represented by an integer.

11. The system of claim 9, wherein the received parameter set NAL unit includes at least two flags f(n), the flags being grouped, and the values for f(n) within the group are represented by an integer.

12. The system of claim 8, wherein the parameter set NAL unit contains a plurality of parameter set IDs.

13. The system of claim 9, wherein the parameter set NAL unit contains a plurality of parameter set IDs.

14. The system of claim 10, wherein the parameter set NAL unit contains a plurality of parameter set IDs.

15. A non-transitory computer readable medium comprising a set of instructions to direct a processor to:
receive a parameter set NAL unit including a reference ID and at least one flag f(n),
for all n, where n is the number of values in a parameter set:
if the at least one flag f(n) is not set, maintain the values v(n) of a parameter set having the same reference ID, and
if the at least one flag f(n) is set, replace the values v(n) of the parameter set having the same reference ID with the values v(n) of the received parameter set NAL unit.

16. The computer readable medium of claim 15, wherein the at least one flag f(n) is represented as a Boolean value.

17. The computer readable medium of claim 15, wherein the received parameter set NAL unit includes at least two flags f(n), the flags being grouped, and the values for f(n) within the group are represented by an integer.

18. The computer readable medium of claim 16, wherein the received parameter set NAL unit includes at least two flags f(n), the flags being grouped, and the values for An) within the group are represented by an integer.

19. The computer readable medium of claim 15, wherein the parameter set NAL unit contains a plurality of parameter set IDs.

20. The computer readable medium of claim 16, wherein the parameter set NAL unit contains a plurality of parameter set IDs.
